(19) United States
(12) Patent Application Publication
(10) Pub. No.: US 2007/0036177 A1
(43) Pub. Date: Feb. 15, 2007

(54) Method and apparatus for managing delivery of video over a digital subscriber line

(75) Inventors: Michael A. Isnardi, Plainsboro, NJ (US); Hui Cheng, Bridgewater, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: SARNOFF CORPORATION

(21) Appl. No.: 11/334,967

(22) Filed: Jan. 19, 2006

Related U.S. Application Data
(60) Provisional application No. 60/707,928, filed on Aug. 12, 2005.

(51) Int. Cl. H04J 1/00; H04J 3/04

(52) U.S. Cl. 370/490; 370/535

(57) ABSTRACT

A method and apparatus for managing delivery of video over a digital-subscriber line is provided. The method includes and the apparatus is adapted for receiving at a multiplexer information indicative of an upstream volume of video traffic for termination to the multiplexer, and for controlling the multiplexer in response to the information. Controlling the multiplexer in response to the information may include regulating, in accordance with the upstream volume of traffic, an amount of traffic buffered by the multiplexer.

### CROSS-REFERENCE TO RELATED APPLICATIONS

This application claims benefit of U.S. provisional patent application Ser. No. 60/707,928, filed Aug. 12, 2005, which is herein incorporated by reference.

### GOVERNMENT RIGHTS IN THIS INVENTION

This invention was made with U.S. government support under contract number NIST 70NANB3H3053. The U.S. government has certain rights in this invention.

### BACKGROUND

1. Field

The following relates to computer networks, and more particularly, to a method and apparatus for managing delivery of video over a digital subscriber line.

2. Description of the Related Art

Traditional suppliers of entertainment services, such as over-the-air television-network service providers, supply their services to end users by broadcasting video content over dedicated bandwidth radio-frequency (“RF”) channels. As such, the traditional suppliers are able to ensure certain quality levels for their delivery of the video content.

With a realization of exchanging data at high-throughput levels afforded by deployment of wireless and/or wired broadband data networks (collectively “data networks”) and the Internet, the traditional suppliers, and to their dismay, new entrant suppliers of entertainment services (“service providers”) have new mediums that afford unique opportunities for offering high-speed media services, such as on-demand video and other video-streaming services.

Typically, each of aforementioned data networks includes a core network and one or more access (or edge) networks that combined are generally capable of providing to one or more of the end users various types of data or content services, which may or might not include high-speed media services. The core network may include a many network elements, but by using sophisticated routing schemas, provides connectivity among a relatively small number of the network elements to operate at high throughput level.

Each of the access networks, on the other hand, generally offers connectivity between the core network and a relatively larger number of the end users. Because of routing decisions and other factors, each of the access networks typically operates at a throughput level that is significantly lower (that is, throughput is typically slower) than the throughput level in the core network.

One type of such access networks are existing telecommunications networks that use digital subscriber lines (“DSL”) to exchange digital signals with one or more of the end users over its “last mile.” Because of an availability of unused frequency spectrum rendered by the DSL, many of the service providers are leveraging or are planning to leverage the DSL to introduce and provide the high-speed media services over the DSL. In addition to the unused frequency spectrum, these service providers also recognize that they can leverage the DSL and associated telecommunications networks (“DSL-access networks”) for such services because they have more control over network engineering and flow control over the DSL-access networks than over general data networks, such as the Internet.

A variety of DSL specifications exist for providing the data services over the last mile using existing copper-wire telephone lines. At present, asymmetric DSL (“ADSL”) is one, if not the most, popular specification for providing the data services to residential end users, and it is increasingly reaching record numbers of such residential end users. When conforming to the ADSL specification, DSL-access networks are capable of providing downstream bandwidth in the range of 6 Mbps over short distances. More typically, however, the DSL-access networks can provide to a broad base of the end users downstream bandwidth in the range of 1.5 Mbps and upstream bandwidth of 384 kbps.

While a potential for delivering high-speed media services over the DSL-access networks is great, such realization has been constrained not only by congestion issues associated with DSL-access networks, but also by the excessive bandwidth required for the high-speed media services. As such, delivering the high-speed media services over such existing DSL-access networks at an acceptable level of service using current technology is, at best, difficult.

The existing DSL-access networks and data networks in general are designed for providing a level of service (that is, a quality of service (“QoS”)), at a best-effort quality level. Under a best-effort quality level, such data networks accommodate the economic average of data traffic, and as such, often experience congestion at various nodes of the data network in response to peaks in data traffic.

The congestion undesirably results in a loss or corruption of one or more packets that contain transmitted data. The loss or corruption of the packets, in turn, causes interruptions or delays in the delivery of the data. Because of its high-bandwidth, and real-time, near-real time or substantially continuous delivery requirements of the high-speed media services, the interruptions or delays result in the delivery of the high-speed media services at a QoS inferior to the aforementioned broadcast channels. Accordingly, the best-effort quality level is not an acceptable QoS level for delivering the high-speed media services.

Furthermore, as the high-speed media services, especially streaming video, proliferates and consumes significant bandwidth flow control techniques for managing congestion and delivery of the high-speed media services increase in importance. Existing flow control strategies for the high-speed media services are minimal.

Typical strategies rely on devices upstream from the DSL for detection of congestion. The devices can initiate flow-control measures, such as stream switching, when detecting network congestion. These flow-control measures typically result in pausing of the stream and rebuffering with relative frequency, causing interruption in the delivery of the high-speed media services. This interruption is more often than not unacceptable to the end users. In turn, the end users can come to detest the service providers that market the entertainment services, and/or discount using the DSL-access networks for providing the high-speed media services. As such, the new entrant suppliers may be economically barred from considering using the DSL-access networks, which may cause such suppliers to turn to other mediums.

Thus, there is a need to provide a method and apparatus that employs a flow control strategy to manage delivery of the high-speed media services to the end users at one or more acceptable QoS levels despite the presence of congestion of the DSL-access network and constrained DSL. Furthermore, this method and apparatus may employ a flow control strategy to manage delivery of the high-speed media services despite a proliferation of data streams and consumption of significant bandwidth associated therewith.

### SUMMARY

The examples disclosed herein are directed to a method for managing and an apparatus configured to manage delivery of video over a digital-subscriber lines (“DSL”). The method includes receiving at a multiplexer, such as a Digital Subscriber Line Access Multiplexer, information indicative of an upstream volume of video traffic for termination to the multiplexer; and controlling the multiplexer in response to the information.

### BRIEF DESCRIPTION OF THE DRAWINGS

It is to be noted, however, that the appended drawings illustrate only typical examples and are therefore not to be considered limiting of scope, for the invention may admit to other equally effective embodiments.

FIG. 1 is a block diagram illustrating an example of broadband data network that may be used to provide to one or more end users high-speed media services.

FIG. 2 is a flow chart illustrating an example method for providing high-speed media services to one or more end users via Digital Subscriber Lines.

FIG. 3 is a block diagram illustrating an example portion of an DSL-access network for delivering high-speed media services to end users via associated customer-premises equipment.

FIG. 4 is a block diagram illustrating example packet architecture for providing traffic information to a Digital Subscriber Line Access Multiplexer.

FIG. 5 is a flow diagram illustrating an example method for using packet architecture to provide traffic information to a Digital Subscriber Line Access Multiplexer.

### DETAILED DESCRIPTION

Example Network

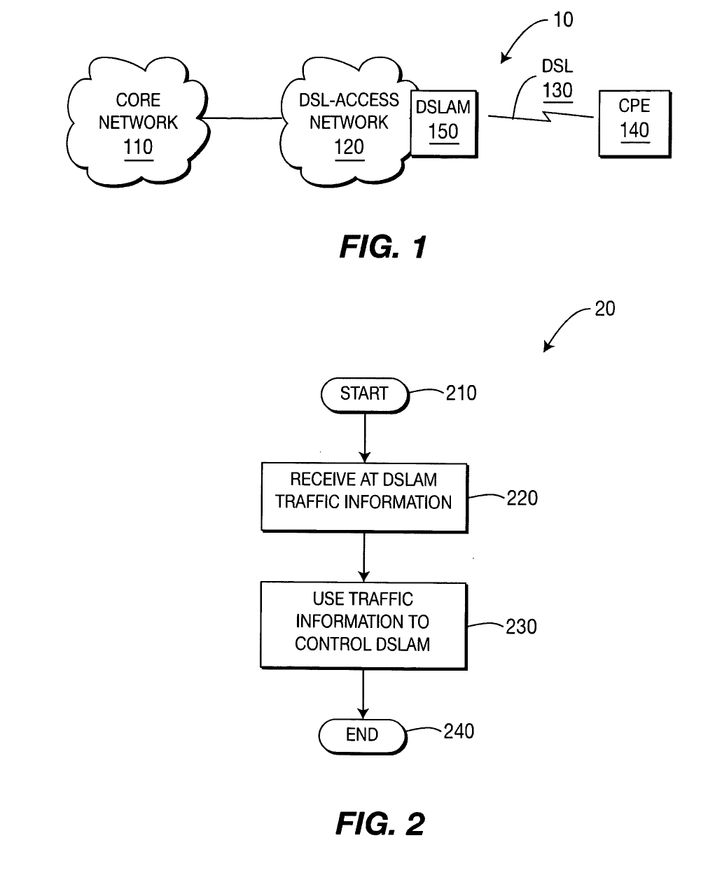

FIG. 1 is a block diagram illustrating an example of broadband data network that may be used to provide to one or more end users high-speed media services. The broadband data network (“data network”) 10 includes a core network 110 that is communicatively coupled to a Digital-Subscriber-Lines access (“DSL-access”) network 120. Combined, the core network 110 and the DSL-access network 120 may provide the high-speed media services over Digital-Subscriber Lines (“DSL”) 130 to the end users via the respective computer-premises equipment. For simplicity, only a one of the customer-premises equipment (“CPE”), namely, CPE 140 is shown.

The core network 110 may be a partial or full deployment of most any telecommunication or computer network. As such, the core network 110 may be or include any part of a public or private, terrestrial wireless or satellite, and/or wireline telecommunications and/or computer network. For example, the core network 110 may include portions of a Public Switched Telephone Network (PSTN), the Internet, proprietary public networks, other wired voice and packet-data networks, and/or wireless voice and packet-data networks, such as, 1 G, 2 G, 2.5 G, 3 G, IEEE 802.11 and Bluetooth telecommunication networks. Accordingly, the core network 110 may include circuit-switched as well as packet-switched elements.

To facilitate a high throughput delivery of the high-speed media services, the core network 110 may include a few or, alternatively, many network elements, most of which are not shown. Using sophisticated routing schemas, the core network 110 may provide connectivity to the DSL-access network 120 using only a few of its network elements. In addition, the core network 110 may be configured in accordance with any number of communication protocols that facilitate providing the high-speed media services downstream to the DSL-access network 120, and/or receiving the high-speed media services from the core network 110.

Being configured to be or include one or more public wired and/or wireless networks, the core network 110 allows a supplier of entertainment services (“service provider”) to provide the high-speed media services in a particular, albeit wide-ranging, geographic coverage area to its subscribers. These subscribers are, generally, any interested member of the public meeting minimal criteria, and of particular interest here, are one or more of the end users that are to obtain the high-speed media services via the DSL-access network 120.

The core network 110 may be alternatively or additionally a private or “enterprise” wired or wireless network. These networks are “private” in that the networks' coverage areas are more geographically limited. Typically, but not necessarily, subscription to such private networks is limited to a select group of subscribers. Networks deployed by many enterprises that only allow their employees, customers, vendors, and suppliers to subscribe exemplify these private networks.

Unlike public networks, such private networks advantageously provide network administrators with greater control over the core network 110, which in turn allows vast customization of the services provided to the end users. When configured to be or include the private networks, the core network 110 may include private-wireline-switching systems, such as private branch exchanges (PBXs) and/or media gateways. The private-wireline-switching systems switch, couple or otherwise connect communications (i) internally, i.e., among the subscribers of the network and (ii) externally, i.e., between the subscribers of the private network and subscribers of public networks. These subscribers may include one or more of the end users.

In addition to the wireline networks, the core network 110 may include private wireless communication systems, such as wireless office telephone systems (“WOTS”) and/or wireless local area networks (WLANs), e.g., Bluetooth and/or IEEE 802.11 WLANs, in lieu of or in addition to wireline switching systems. Similar to public networks, these private networks may be integral to or integrated with other private and public satellite, terrestrial wireless, and wireline networks to provide a wider-ranging coverage area. It is recognized, however, that differences between private and public networks may only be a matter of semantics due to convergence between communication technologies.

Like the core network 110, the DSL-access network 120 may be or include any part of a public or private, terrestrial wireless or satellite, and/or wireline telecommunications and/or computer network. Additionally, the DSL-access network may be configured to communicate the high-speed media services using any number of protocols and in any manner consistent with providing the high-speed media service using the DSL 130 to the end user (via the CPE 140).

These protocols may include standardized, proprietary, open-source, and freely-available communication protocols for communicating data in circuit-switching and/or packet data networks. In addition to those described above, below or are otherwise known, the communication protocols for communicating over the DSL 130 may include any protocol associated with DSL; also known as “xDSL protocols.”

Table 1 includes a non-exhaustive list of the xDSL protocols, all of which are incorporated herein by reference. For each of the entries, Table 1 includes a protocol name; a protocol number, if any; downstream data rate and upstream data rate. Where appropriate, the downstream and upstream data rates provided are theoretical maximums.

TABLE 1

| | | Downstream | |
|---|---|---|---|
| Protocol Name | Protocol | Rate | Upstream Rate |
| Asymmetric- | ANSI T1.413- | 8 Mbit/s | 1.0 Mbit/s |
| Digital- | 1998 Issue 2 | | |
| Subscriber- | | | |
| Line (“ADSL”) | | | |
| ADSL (G.DMT) | ITU G.992.1 | 8 Mbit/s | 1.0 Mbit/s |
| ADSL Lite | ITU G.992.2 | 1.5 Mbit/s | 0.5 Mbit/s |
| (G.Lite) | | | |
| ADSL2 | ITU G.992.3/4 | 12 Mbit/s | 1.0 Mbit/s |
| ADSL2 | ITU G.992.3/4 | 12 Mbit/s | 3.5 Mbit/s |
| | Annex J | | |
| ADSL2 | ITU G.992.3/4 | 12 Mbit/s | 1.0 Mbit/s |
| | Annex L | | |
| ADSL2+ | ITU G.992.5 | 24 Mbit/s | 1.0 Mbit/s |
| ADSL2+ | ITU G.992.5 | 24 Mbit/s | 1.0 Mbit/s |
| | Annex L¹ | | |
| ADSL2+ | ITU G.992.5 | 24 Mbit/s | 3.5 Mbit/s |
| | Annex M | | |
| Rate Adaptive | Non-standard | Adaptive - | Adaptive - |
| Digital | | varies between | varies between |
| Subscriber | | 0.5 Mbit/s and | 0.5 Mbit/s and |
| Line | | 64 kbit/s | 64 kbit/s |
| (“RADSL”) | | | |
| High Bit Rate | Non-standard | See below | See below |
| Digital | | | |
| Subscriber | | | |
| Line (“HDSL”) | | | |
| Symmetric | ITU G.991 | Variable - | Variable - |
| Digital | See also, | (1) 192 kbit/s | (1) 192 kbit/s |
| Subscriber | G.SHDSL | to 2,304 kbit/s | to 2,304 kbit/s |
| Line (“SDSL”) | | (one pair) or | (one pair) or |
| | | (2) 384 kbit/s | (2) 384 kbit/s |
| | | to 4,608 kbit/s | to 4,608 kbit/s |
| | | (two pair) | (two pair) |
| Very high bit- | ITU-T G.993.1 | 12.9 to 52.8 | 1.5 to 2.3 Mbit/s |
| rate Digital | | Mbit/s | |
| Subscriber | | | |
| Line (“VDSL”) | | | |
| Very-High-Bit- | ITU-T G.993.2 | Up to 200 Mbit/s | Up to 200 Mbit/s |
| Rate Digital | | | |
| Subscriber | | | |
| Line 2 | | | |
| (“VDSL2”) | | | |

Using the HDSL protocol, the DSL-access network 120 can carry equal amount of bandwidth over the DSL 130 in both directions. The theoretical maximum data rate that the DSL-access network 120 can carry when using the HDSL protocol is 1.544 Mbit/s (similar to a T1 line) in North America or 2.048 Mbits/s (similar to an E1 line) in Europe. When complying with the ITU G.992.1, ITU G.992.2, and ITU G.992.3/4 protocols, the DSL-access network 120 may provide the high-speed media services over the DSL 130 by an extra 256 kbit/s above the upstream rates shown in the Table 1. To do this, the DSL-access network 120 may use bandwidth normally reserved for voice calls.

Without regard to the particular xDSL protocol employed, the DSL-access network 120 typically facilitates high-throughput delivery of the high-speed media services using many network elements; most of which are not shown. Although less typical, the DSL-access network 120 may employ only a few network elements; again most of which are not shown. Via its network elements, whether many or few, the DSL-access network 120 provides connectivity between the core network 110 and a relatively large number of the end users using the DSL 130.

To provide the connectivity for providing the high-speed media services to the end users, the DSL-access network 120 may include and employ one or more multiplexers, which may be embodied as Digital-Subscriber-Line-Access Multiplexers (“DSLAMs”). These DSLAMs are typically located on one or more edges of the DSL-access network 120. The DSLAMs are located on the edges because, primarily, traffic-bearing capacity of DSL, such as the DSL 130, decreases with an increase in distance between the DSLAMs and the CPE 140.

For example, the DSLAMs may be located at one end of the last mile at a central office (“CO”) or at one or more sites remote from the CO or other network locations that comply with one or more of the xDSL specifications. Such xDSL specifications generally include engineering rules for physical specifications of the DSL 130, which may include lengths and wire gauges of the DSL 130.

Each of the DSLAMS may have (i) one or few input terminations for communicatively coupling to the core network 110, and (ii) one to thousands of output terminations for communicatively coupling to the CPE 140 of the end-users, which may be embodied as modems or other terminal devices configured to communicate in accordance with one (or more) of the xDSL specification used the DSLAMs. For simplicity, only one of the DSLAMs, namely, DSLAM 150 is shown.

Example Operation

FIG. 2 is a flow diagram illustrating an example method 20 for providing high-speed media services to one or more end users via DSL. Although the method 20 may be carried out by different architectures, the following is described with reference to the example network 10 of FIG. 1, for simplicity.

The method 20 starts at termination block 210 after the end user requests, via the CPE 140, the high-speed media services. Responsive to the request, the DSLAM 150 may receive information indicative of an upstream volume of traffic associated with the high-speed media services (“upstream-media traffic”), as shown in process block 220.

The DSLAM 150 may receive the information associated with the upstream-media traffic (“traffic information”), for example, from one or more elements of the network 10 that are located upstream from the DSLAM 150 (“upstream-network elements”). As described in more detail below, one or more of these upstream-network elements may be embodied as video encoders that may originate the traffic information.

To facilitate the exchange of the traffic information between the DSLAM 150 and the upstream-network elements, the traffic information may be carried in a data packet. The data packet typically includes a header, payload, and optionally, a footer. The traffic information may be placed in, integrated into, combined with other information in the header, body and/or footer of the data packet.

After receiving the traffic information, the traffic information is used to control the DSLAM 150 so it is capable of delivering, at an acceptable quality of service, the high-speed media services to the end user via the CPE 140, as shown in process block 230. As an example of using the traffic information for such control, the DSLAM 150 may regulate, in accordance with the volume of the upstream-media traffic, an amount of traffic (media service or otherwise) buffered by the DSLAM 150 (referred to hereinafter as “DSLAM-buffered traffic”). And when the traffic information is carried in the data, the DSLAM 150 may (i) obtain the traffic information from the data packet (e.g., from the header), and then (ii) regulate, in accordance with the volume of the upstream-media traffic, the DSLAM-buffered traffic.

To facilitate the regulation, the DSLAM 150 may remove, drop or “dent” one or more portions of the DSLAM-buffered traffic so as to accommodate one or more portions of the upstream-media traffic as or after it arrives. Accordingly, when the traffic information indicates that the volume of the upstream-media traffic is heavy as compared to a current throughput of the DSLAM 150, the DSLAM may be controlled to dent the DSLAM-buffered traffic.

Alternatively and/or additionally, the DSLAM 150 may regulate the DSLAM-buffered traffic by regulating an amount of storage of the DSLAM 150 that is available to store the volume of upstream-media traffic so as to minimize denting of the DSLAM-buffered traffic. This may be carried out when the traffic information indicates that the volume of upstream-media traffic is light as compared to the current throughput of the DSLAM 150.

As another example, the DSLAM 150 may regulate the DSLAM-buffered traffic by (i) dropping one or more portions of the DSLAM-buffered traffic when the traffic information indicates that the volume of upstream-media traffic might cause an overrun of a storage capacity of the DSLAM 150, and/or (ii) regulating an amount of storage of the DSLAM 150 that is available to store the volume of upstream-media traffic so as to minimize denting of the DSLAM-buffered traffic when volume of upstream-media traffic might not cause the overrun of the storage of the DSLAM 150.

While the DSLAM 150 may haphazardly dent one or more portions of the DSLAM-buffered traffic to accommodate the volume of upstream-media, the DSLAM 150 may instead dent one or more portions of the DSLAM-buffered traffic that are less important than the upstream-media traffic. To facilitate this, the traffic information may include one or more indications noting an importance level associated with one or more portions of the upstream-media traffic. The DSLAM 150 may use the importance level to determine whether the upstream-media traffic is more important than one or more portions of the DSLAM-buffered traffic. Responsive to determining that one or more portions of the upstream-media traffic is more important than the one or more portions of the DSLAM-buffered traffic, the DSLAM 150 may then dent the portion or portions of the DSLAM-buffered traffic that are less important.

Importance, and the levels thereof (i.e., importance hierarchy), may be a function of one or more types of traffic contained in the DSLAM-buffered traffic. For example, DSLAM-buffered traffic that has a best-effort level of QoS may be considered to be less important than DSLAM-buffered traffic that has a guaranteed delivery level of QoS, such as previously buffered high-speed media service traffic. Alternatively, the importance hierarchy may be a function of the types of video frames present in packets of the DSLAM-buffered traffic, and in particular, whether or not such is used as a reference to decode any future frames.

The DSLAM 150 may dent the portion or portions of the DSLAM-buffered traffic that are less important than the upstream-media traffic in a hierarchal manner. For example, the DSLAM-buffered traffic may be divisible into a number of parts, of which a first part is more important a second part. The DSLAM 150 may dent, initially, at least one portion of the second part to make storage of the DSLAM 150 available to buffer the volume of upstream-media traffic. If denting such portion of the second part does not make enough storage of the DSLAM 150 to accommodate the volume of the upstream-media traffic when it arrives, the DSLAM 150 may dent more portions of the second part. In addition, the DSLAM 150 may dent one or more portions of the first part after denting all portions of the second part. That is, the DSLAM 150 may dent the portions of the first part when denting all of the second part does not make enough storage available to buffer the volume of the upstream-media traffic.

At termination block 240, the method 20 terminates.

Example Digital Subscriber Line Access Multiplexer

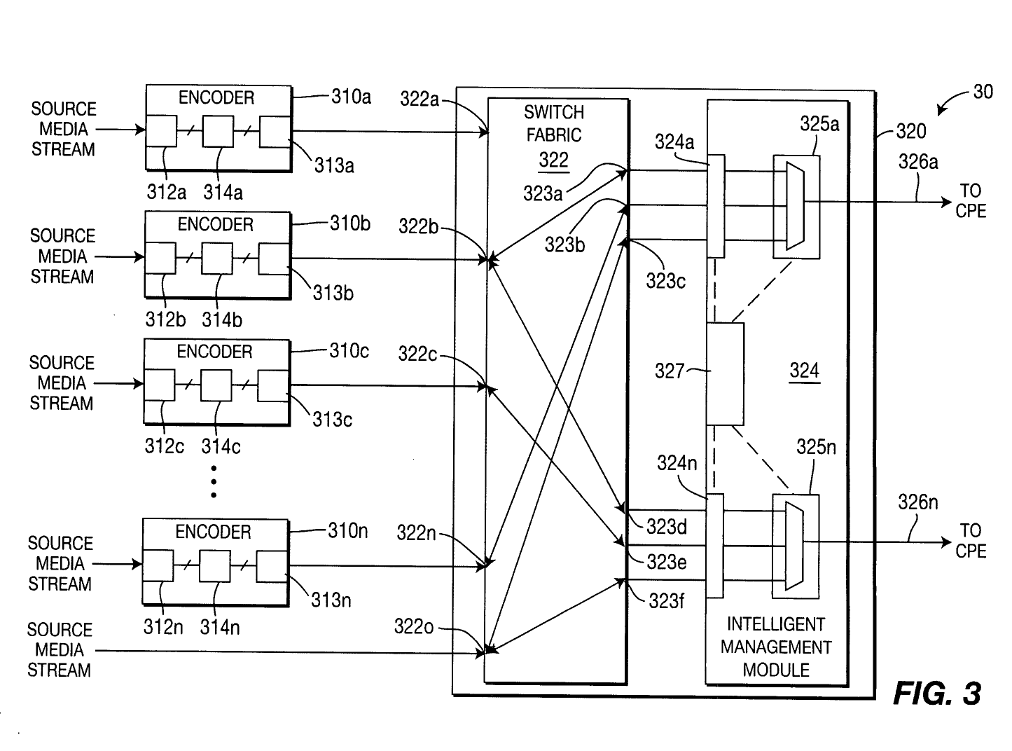

FIG. 3 is a block diagram illustrating an example portion of a DSL-access network 30 for delivering high-speed media services to end users via associated CPE. To facilitate such delivery, the DSL-access network 30 may include a number of media encoders 310a-310n that are communicatively coupled to a Digital-Subscriber-Line-Access Multiplexer (“DSLAM”) 320.

The DSL-access network 30 may include other elements and may include more or less of the media encoders 310a-310n. In addition, the DSLAM 320 may embody the DSLAM 150 and/or any other of the DSLAMs of the network 10 (FIG. 1). For convenience, the DSLAM 320 and the DSL-access network 30 are described with reference to network 10. The DSLAM 320, nonetheless, may be described with reference to most any DSL-access network.

As set forth in more detail below, the media encoders 310a-310n are each configured to (i) form one or more encoded-media streams by processing one or more high-speed media streams received therein (“upstream-media streams”), and (ii) exchange with the DSLAM 320 traffic information and the encoded-media streams. The DSLAM 320, in turn, may provide such encoded-media streams to the associated CPE.

Exchange of the upstream-media and the encoded-media streams across DSL-access network 30 may be carried out using one or more communication protocols. Such communication protocols may include the well known, Internet Protocol (“IP”), asynchronous transfer mode (“ATM”) protocol, the Synchronous Optical Network (“SONET”) protocol, the Transport Control Protocol (“TCP”), User Datagram Protocol (“UDP”), Real-Time Protocol (“RTP”), any of the xDSL protocols, and the like.

Between the elements of the DSL-access network 300 upstream from, and including, the media encoders 310a-310n, the exchange of the upstream-media streams may be carried out using packets formatted in accordance with IP over ATM over SONET protocols (“SONET/ATM/IP”), TCP encapsulated within IP (“TCP/IP”), UDP encapsulated within IP (“UDP/IP”), and the like. Downstream from the DSLAM 320 to the associated CPE, the exchange of the encoded-media streams (and variants thereof) may be carried out using RTP encapsulated within UDP encapsulated within IP (“RTP/UDP/IP”), RTP encapsulated within TCP encapsulated within IP (“RTP/UDP/IP”), and the like. And from between the media encoders 310a-310n and the DSLAM 320, the exchange of the encoded-media streams (and variants thereof) may be carried out using RTP/UDP/IP, RTP/TCP/IP, proprietary and agreed-upon adaptations of the RTP/UDP/IP, proprietary and agreed-upon adaptations of RTP/TCP/IP, and the like.

Each of the media encoders 310a-310n includes at least one input for receiving the upstream-media streams from one or more upstream media sources (not shown), and at least one output for outputting an encoded-media stream associated with the upstream-media streams received at its inputs. In between the inputs and outputs of the media encoders 310a-310n are respective encoder-input buffers 312a-312n, encoder-output buffers 313a-313n, and logic 314a-314n. The media encoders 310a-310n may include other elements as well.

Each of the encoder-input buffers 312a-312n and each of the encoder-output buffers 313a-313n may be formed from one or more memory elements, such as memory configured in accordance with a Random Access Memory (“RAM”) family of memory, and the like. Each of the encoder-input buffers 312a-312n and each of the encoder-output buffers 313a-313n may be separated into one or more portions. Each portion of the encoder-input buffers 312a-312n may be employed to buffer different or redundant portions the upstream-media streams received, and each portion of the encoder-output buffers 313a-313n may be employed to buffer different or redundant portions the encoded-media stream processed by the logic 314a-314n, respectively.

Each of the logic 314a-314n may be embodied in hardware, software or any combination thereof. The logic 314a-314n may form the encoded-media streams by encoding, compressing and/or smoothing the upstream-media streams retrieved from the encoder-input buffers 312a-312n or from the inputs of the media encoders 310a-310n directly.

The logic 314a-314n may encode, compress and/or smooth (collectively “process”) the upstream-media streams in accordance with any of a number of media encoding protocols, including the MPEG family of protocols under ISO/IEC JTC1/SC29 WG11, and the like. The MPEG family of protocols, by the way, includes MPEG-1, MPEG-2, MPEG-3, MPEG-4, Simple Profile and Advanced Simple Profile, H.264/MPEG-4 AVC, MPEG-7, and MPEG-21. In accord with the media encoding protocols, each of the logic 314a-314n may process the upstream-media streams using a Variable Bit Rate (“VBR”), a constant Bit Rate (“CBR”) or other some combination thereof.

The VBR provides a number of advantages over the CBR. One such advantage is efficiency. This efficiency may be realized through a savings of bits needed to encode the upstream-media streams when such upstream-media streams are of differing complexity. That is, instead of using a constant Bit Rate, which has to be fixed at a rate to accommodate the largest encoding need, the logic 314a-314n may save bits by using a first bit rate for the media streams that are highly complex, and a second bit rate for the media streams that are less complex.

For example, the logic 314a-314n may use the first bit rate to process the media streams that contain action scenes, and use the second rate to process the media streams that contain news scenes. In this example, the logic 314a-314n uses the first rate, which is larger than the second rate, because processing the media streams that contain action scenes takes more bits than processing the media streams that contain the news scenes. Other rates are possible as well.

In addition to being configured to form the encoded-media streams, the logic 314a-314n may also generate the traffic information, and then integrate into, incorporate or otherwise combine such traffic information with the encoded-media streams. The traffic information provides the DSLAM 320 with a “look ahead” or indication of the volume of the upstream-media and/or encoded-media streams presently at or going to be at the media encoders 310a-310n. As such, the traffic information provides the DSLAM 320 with an indication of future congestion, which as described in above and below, allows the DSLAM 320 to manage the flow of the encoded-media streams to the end users.

To facilitate the look ahead, the logic 314a-314n may, for example, generate information associated with current or future states (“upstream-state information”) of the media encoders 310a-310n, respectively. The logic 314a-314n may generate the upstream-state information in any number of ways, including generating it as a function of (i) the processing of the upstream-media streams, (ii) states of the encoder-output buffers 313a-313n, and (iii) types, sizes, and priorities of portions of the encoded-media streams present in the encoder-output buffers 313a-313n.

For example, each of the logic 314a-314n may process a number of images of its upstream-media stream as a group. To facilitate such processing, each of the logic 314a-314n may collect statistics associated with the number of images prior to encoding the number of images into the group.

Such statistics may include an estimate of the volume of traffic for a given time frame. This estimate may be qualitative and/or quantitative. The qualitative estimate of traffic may indicate, for example, that the volume of traffic for the given time frame is high, normal, and/or low. The quantitative estimate of traffic may indicate, for example, that the volume of traffic to be received next is a given number of bytes (e.g. 33 kilobytes), and/or the volume of traffic after next is another given number of bytes (e.g., 10 kilobytes). Another example of the quantitative estimate of traffic may indicate that the volume of traffic has a target bit rate of a given number of bytes/second.

The statistics may be used by each of the logic 314a-314n to encode the number of images into the group (“encoded group”). By collecting and encoding in accordance with the statistics, the logic 314a-314n may be operable to allocate all available bits of the number of images in an optimal manner, and translate the statistics into the traffic information.

Alternatively and/or additionally, each of the logic 314a-314n may perform a multi-pass encoding to form the encoded group. The multi-pass encoding may involve (i) collecting statistics on a group of images on a first pass, (ii) encoding in accordance with such statistics, and then (iii) repeating such collecting and encoding a second time (or a multiple of times). The logic 314a-314n may perform the multi-pass encoding to achieve optimal bit allocation.

As noted above, the logic 314a-314n may generate the upstream-state information as a function of states of the encoder-output buffers 313a-313n, respectively. The states of the encoder-output buffers 313a-313n may be indicative of the available capacity of such buffers. One state, for example, may be ten-percent available. Another state may be, for example, ninety-percent available. The states of the encoder-output buffers 313a-313n may be other values and/or be of a different type, as well. After determining the respective states of the encoder-output buffers 313a-313n, the logic 314a-314n may include the states in the upstream-state information.

Alternatively and/or additionally, each of the logic 314a-314n may examine the portions of the encoded-media stream present in the respective encoder-output buffers 313a-313n to determine a type, size and priority of such portions of the encoded-media streams. After so determining, the logic 314a-314n may also include the types, sizes and priorities in the upstream-state information.

In addition to being configured to generate the upstream-state information, the logic 314a-314n may integrate into, incorporate or otherwise combine the upstream-state information with one or more portions of previously encoded-media streams or media streams undergoing processing. These previously encoded-media streams may be residing in the respective encoder-output buffers 313a-313n and/or present on the outputs of the media encoders 310a-310n, respectively.

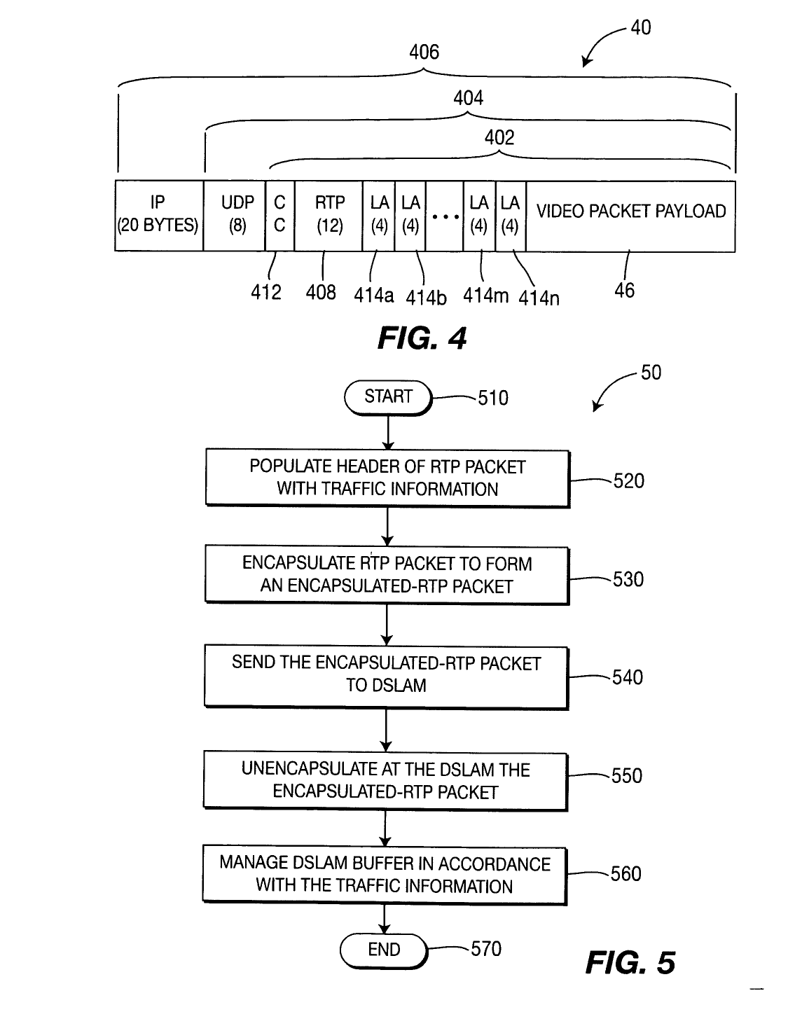

To facilitate this, the logic 314a-314n may, for example, attach or otherwise append the upstream-state information to the previously encoded-media streams. An example of this is described below with reference to FIG. 4.

The logic 314a-314n may further exchange the respective encoded-media streams with DSLAM 320 via the encoder-output buffers 313a-313n, respectively. Alternatively, the logic 314a-314n may exchange the respective encoded-media streams with DSLAM 320 without using the encoder-output buffers 313a-313n, respectively, but instead, via the outputs of the respective media encoders 310a-310n directly.

The DSLAM 320 may receive the encoded-media streams from outputs of the media encoders 310a-310n, and provide the encoded-media streams to the associated CPE via a number of output channels. For simplicity, only two of the output channels, namely, first and second output channels 326a, 326n, are shown. The first and second channels 326a, 326b may be communicatively coupled to the associated CPE of two of the end users, and provide to these end users, at an acceptable level of QoS, first and second encoded-media streams, respectively.

To facilitate such functions, the DSLAM 320 may include a DSLAM-switch fabric 322 and an intelligent-management module 324. The DSLAM-switch fabric 322 includes a number of DSLAM inputs 322a-322o, each of which may communicatively couple to the outputs of the respective media encoders 310a-310n and directly to a media source. As such, the DSLAM inputs 322a-322n may receive from (or exchange with) the media encoders 310a-310n the encoded-media streams. The DSLAM input 322o may receive from (or exchange with) one of the sources of media streams an upstream-media stream.

The DSLAM-switch fabric 322 includes a number of switches. Each of the switches may communicatively couple the DSLAM inputs 322a-322o to one or more of the output channels 326a, 326n. These couplings may be made via the intelligent-management module 324 and the switch-fabric terminations, such as switch-fabric terminations 322a-323f. Again for simplicity, only some of the switch fabric terminations are shown.

The intelligent-management module 324 may include a multiplexing gate for each of the output channels, one or more DSLAM buffers to buffer a finite amount of the encoded-media stream, and management logic 327. For simplicity, only two multiplexing gates, namely, first and second multiplexing gates 325a, 325n are shown.

In addition, two DSLAM buffers are shown, namely, first and second DSLAM buffers 324a, 324n to buffer encoded-media streams for the first and second multiplexing gates 325a, 325n, respectively. Alternatively, the first and second DSLAM buffers 324a, 324n may be combined into a single buffer, and as such, may buffer encoded-media streams for the first and second multiplexing gates 325a, 325n collectively. The first and second DSLAM buffers 324a, 324n may be formed from one or more memory elements, such as memory configured in accordance with a Random Access Memory (“RAM”) family of memory, and the like.

The first multiplexing gate 325a, may multiplex (i) the encoded-media stream from the media encoder 310b, (ii) the encoded-media stream from the media encoder 310n, and (iii) the un-encoded media stream onto the output channel 326a. The second multiplexing gate 325n may multiplex (i) the encoded-media stream from the media encoder 310b, (ii) the encoded-media stream from the media encoder 310c, and (iii) the un-encoded media stream onto the output channel 326n.

When multiplexing such streams using ADSL, the first multiplexing gate 325a, may multiplex the encoded-media streams from the media encoders 310b, 310n, which are encoded using VBRs, onto the output channel 326a, which uses a CBR. Similarly, the second multiplexing gate 325a, may multiplex the encoded-media streams from the media encoders 310b, 310c, which are encoded using VBRs, into the output channel 326n, which uses a CBR.

The management logic 327, which may be embodied in hardware, software or some combination thereof, may be communicatively coupled each of the first and second multiplexing gates 325a, 325n, and the DSLAM buffers 324a, 324n. The management logic 327 may monitor the upstream-state information attached or appended to the encoded-media streams in the DSLAM buffers 324a, 324n. The management logic 327 may take certain actions in accordance with the upstream-state information.

One of these actions may be to manage an amount of available storage of the DSLAM buffers 324a, 324n as opposed to unconditionally denting such DSLAM buffers 324a, 324n, which leads to an unacceptable level of QoS. For example, the management logic 327 may allow the available storage in the DSLAM buffers 324a, 324n to approach maximum capacity or surpass an upper capacity threshold when the upstream-state information indicates that the bit rate of the encoded-media streams for the next interval of time is significantly lower than a present bit rate, and thus, will not cause overflows of the DSLAM buffers 324a, 324n.

On the other hand, the management logic 327 may dent one or more portions of the encoded-media streams in the DSLAM buffers 324a, 324n when the upstream-state information indicates that the bit rate of the encoded-media streams for the next interval of time will cause overflows of the DSLAM buffers 324a, 324n. The management logic 327 may dent such portions of the encoded-media streams in accord with the types, sizes and priorities included in the upstream-state information, if any. The management logic 327 may manage the DSLAM buffers 324a, 324n in other intelligent manners.

Example Packet Architecture for Providing the Traffic Information to a DSLAM

FIG. 4 is a block diagram illustrating packet architecture 40 for providing the traffic information to a DSLAM, such as DSLAM 320. The packet architecture 40 may be formatted in accordance with any of the protocols noted above, but for simplicity, the packet architecture 400 is formatted in accordance with RTP/UDP/IP.

The packet architecture 400 includes an RTP packet 402 encapsulated in a UDP packet 404, which in turn, is encapsulated in an IP packet 406. The RTP packet 402 includes a standard, fixed RTP header 408, a payload 410 for carrying a portion of an encoded-media stream, a Contributing Source (“CSRC”) count field 412, and a plurality of CSRC-Identifier fields 414a-414n for carrying the traffic information.

The payload 410 may include a single frame of the encoded-media stream. As such, the RTP packet 402 may be used to associate the traffic information with each frame of the encoded-media stream.

In accordance with the RTP protocol, the CSRC count (“CC”) field 412 and the CSRC-Identifier fields 414a-414n are part of an extended header of the RTP packet 402. The CSRC count (“CC”) field 412a is a 4-bit value, resides before the RTP header 408 and defines how many of the CSRC-Identifier fields 414a-414n are included in the extended header.

The CSRC-Identifier fields 414a-414n are 32-bit values, and reside between the RTP header 408 and the payload 410. The RTP packet 402 may include up to 15 of the CSRC-Identifier fields 414a-414n.

Each of the CSRC-Identifier fields 414a-414n may represent the traffic information in chronological ordered time increments. As an example, the time increments do not overlap, and do not have gaps between them. The CSRC-Identifier field 414a may represent a time increment immediately following a current time; the CSRC-Identifier field 414b may represent a next time increment, and so on. Because the RTP packet 402 can include up to 15 of the CSRC-Identifier fields 414a-414n, up to fifteen consecutive time increments can be included in each RTP packet.

Each of the CSRC-Identifier fields 414a-414n may, in turn, include three subfields (not shown). These subfields may be formatted as follows:

M₀₋₃ T₀₋₁₁ V₀₋₁₅,

where:
1. M is a 4-bit mode field with the following meaning:
   a. ‘0000’: interpret V0-15 as a bit rate value in units of kbps;
   b. ‘0001’: interpret V0-15 as a picture size value in units of bits; and
   c. all other values: reserved for future use
2. T is a 12-bit time increment field that indicates the duration of the time increment in ms
3. V is a 16-bit value whose meaning is determined by M

Using this format, bit rate profiles of the encoded-media streams of any shape may be included in the traffic information. For instance, a bit rate profile of the volume of traffic may be specified as follows:

a first rate of 321 kbps for 98 milliseconds, followed by

a second rate of 634 kbps for 22 milliseconds, followed by

a third rate of 519 kbps for 38 milliseconds.

Other schemes are possible as well.

Note also that it is not necessary to send LA information in every RTP header. For increased efficiency, the LA information can be sent less frequently. When picture size info is being sent, for instance, sending the LA information every RTP header could mean repeating most of the values, which is inefficient. One could send this information less often (e.g., every five frames) and still provide useful LA information to the DSLAM 320.

Example Use of a Packet Architecture

FIG. 5 is a flow diagram illustrating an example method 50 for using packet architecture, such as the packet architecture 40, to provide a DSLAM, such as DSLAM 320 the traffic information. While the method 50 may be described with reference to most any network architecture, the method 50 is described herein with respect to the DSL-access network 30.

At termination block 510, the method 50 starts after receiving a request for the high-speed media stream for delivery over output channel 326a. Assuming that the media encoder 310b is operable to provide the encoded-media stream, the logic 314b of media encoder 310b populates the CC field 412 and the CSRC-Identifier fields 414a-414n with the traffic information, as shown in process block 520.

The logic 314b of media encoder 310b then encapsulates the RTP Packet 402 to in the UDP packet 404, and then into the IP packet 406 to form an encapsulated-RTP packet, as shown in process block 530. If the media encoder 310b uses a separate entity to provide RTP/UDP/IP encapsulation of the encoded-media stream, the traffic information may be sent from the media encoder 310b to this separate entity as frame-synchronous metadata.

This may be done by simply prepending each frame of the encoded-media stream with N, wherein N is in the range 0-15, 32-bit values of the chronological ordered time increments of the traffic information, and prepending to these 32-bit values a unique 48-bit syncword of the form “0×00 0×00 0×00 0×00 0×01 0×0y,” where y is a 4-bit value that indicates the number of the chronological ordered time increments of the traffic information.

In turn, the separate entity then searches for the unique 48-bit syncword, transfers the y bits into the CC field 412 and transfers the chronological ordered time increments of the traffic information into the CSRC-Identifier fields 414a-414n.

The media encoder 310b (or the separate entity) then sends the encapsulated-RTP packet to the DSLAM 320, as shown in process block 540. After receipt of the encapsulated-RTP packet, the DSLAM 320 removes the encapsulation of the encapsulated-RTP packet to yield the traffic information, as shown process block 550. The DSLAM 320 manages its DSLAM-buffer 324a in accordance with the traffic information. At termination block 570, the method 50 terminates.

Conclusion

Although the invention is illustrated and described herein with reference to specific embodiments, the invention is not intended to be limited to the details shown. Rather, various modifications may be made in the details without departing from the scope of invention.

While the foregoing is directed to examples of the present invention, other and further embodiments of the invention may be devised without departing from the basic scope thereof, and the scope thereof is determined by the claims that follow.

What is claimed is:

1. A method for managing delivery of video over a digital-subscriber line, the method comprising:
receiving at a multiplexer information indicative of an upstream volume of video traffic for termination to the multiplexer; and
controlling the multiplexer in response to the information.

2. The method of claim 1, wherein controlling the multiplexer in response to the information comprises: regulating, in accordance with the upstream volume of traffic, an amount of traffic buffered by the multiplexer.

3. The method of claim 2, wherein regulating an amount of traffic buffered by the multiplexer comprises: dropping at least a portion of the traffic buffered by the multiplexer to accommodate the upstream volume of video traffic.

4. The method of claim 3, wherein the dropping at least a portion of the traffic buffered by the multiplexer occurs when the information indicates that the upstream volume of video traffic is heavy [as compared to a throughput of the multiplexer].

5. The method of claim 2, wherein regulating an amount of traffic buffered by the multiplexer comprises: regulating an amount of storage of the multiplexer that is available to store the upstream volume of video traffic so as to minimize dropping of the traffic buffered by the multiplexer.

6. The method of claim 5, wherein the regulating an amount of storage of the multiplexer that is available occurs when the information indicates that the upstream volume of video traffic is light [as compared to a throughput of the multiplexer].

7. The method of claim 2, wherein regulating an amount of traffic buffered by the multiplexer comprises:
dropping at least a portion of the traffic buffered by the multiplexer when the information indicates that the upstream volume of video traffic will cause an overrun of storage of the multiplexer; and
regulating an amount of storage of the multiplexer that is available to store the upstream volume of video traffic so as to minimize dropping of the traffic buffered by the multiplexer when the information indicates that the upstream volume of video traffic will not cause an overrun of storage of the multiplexer.

8. The method of claim 2, wherein regulating an amount of traffic buffered by the multiplexer comprises: dropping at least one portion of the traffic buffered by the multiplexer to accommodate the upstream volume of video traffic when the information indicates that the upstream volume of video traffic is more important than an amount of storage of the multiplexer that is available to buffer traffic.

9. The method of claim 8, wherein the traffic buffered by the multiplexer comprises first and second parts, wherein the first part is more important than the second part, and wherein dropping at least one portion of the traffic buffered by the multiplexer comprises:
dropping at least one portion of the second part to make storage of the multiplexer available to buffer the upstream volume of video traffic; and
dropping at least a portion of the first part when dropping all portions of the second part does not make enough storage of the multiplexer available to buffer the upstream volume of video traffic.

10. The method of claim 1, wherein the information indicative of an upstream volume of video traffic comprises: encoder-traffic information, wherein the encoder-traffic is indicative of the upstream volume of video traffic occurring on at least one encoder.

11. The method of claim 1, wherein receiving at a multiplexer information indicative of an upstream volume of video traffic comprises: receiving at the multiplexer a data packet, wherein the data packet comprises a header, and wherein the header comprises the information indicative of an upstream volume of video traffic.

12. The method of claim 11, wherein controlling the multiplexer in response to the information comprises:
obtaining from the header the information indicative of an upstream volume of video traffic; and
regulating, in accordance with the upstream volume of video traffic, an amount of buffering of traffic buffered by the multiplexer.

13. A multiplexer for managing delivery of video over a digital-subscriber line, the multiplexer comprising:
a buffer for buffering traffic received by the multiplexer; and
logic adapted to (i) receive information indicative of an upstream volume of video traffic for termination to the multiplexer, and (ii) control the buffer in response to the information.

14. The multiplexer of claim 13, wherein the logic adapted to control the buffer comprises: logic adapted to regulate, in accordance with the upstream volume of video traffic, an amount of traffic buffered in the buffer.

15. The multiplexer of claim 14, wherein the logic adapted to regulate an amount of traffic buffered in the buffer comprises: logic adapted to drop at least a portion of the traffic buffered by the buffer to make space in the buffer available to accommodate the upstream volume of video traffic.

16. The multiplexer of claim 15, wherein the logic is adapted to drop the at least a portion of the traffic when the information indicates that the upstream volume of video traffic is heavy [as compared to a throughput of the multiplexer].

17. The multiplexer of claim 14, wherein the logic is adapted to regulate the amount of traffic buffered in the buffer so as to minimize dropping of the traffic buffered by the multiplexer.

18. The multiplexer of claim 17, wherein the logic is adapted to regulate an amount of traffic buffered in the buffer when the information indicates that the upstream volume of video traffic is light [as compared to a throughput of the multiplexer].

19. The multiplexer of claim 14, wherein the logic adapted to regulate an amount of traffic buffered in the buffer comprises:
logic adapted to drop at least a portion of the traffic buffered in the buffer when the information indicates that the upstream volume of video traffic will cause an overrun of the buffer; and
logic adapted to minimize dropping of the traffic buffered in the buffer when the information indicates that the upstream volume of video traffic will not cause an overrun of the buffer.

20. The multiplexer of claim 14, wherein the logic adapted to regulate an amount of traffic buffered in the buffer comprises: logic adapted to drop at least one portion of the traffic buffered in the buffer to accommodate the upstream volume of video traffic when the information indicates that the upstream volume of video traffic is more important than the at least one portion of the traffic buffered in the buffer.

21. The multiplexer of claim 20, wherein the traffic buffered by the buffer comprises first and second parts, wherein the first part is more important than the second part, and wherein the logic adapted to drop at least one portion of the traffic buffered in the buffer comprises:
logic to drop at least one portion of the second part to make space in the buffer to accommodate the upstream volume of video traffic; and
dropping at least a portion of the first part when dropping all portions of the second part does not make enough space in the buffer to accommodate the upstream volume of video traffic.

22. The multiplexer of claim 13, wherein the information indicative of an upstream volume of traffic comprises: encoder-traffic information, wherein the encoder-traffic is indicative of the upstream volume of video traffic occurring on at least one encoder.

23. The multiplexer of claim 13, wherein the logic is adapted to receive the information indicative of an upstream volume of video traffic in a data packet, wherein the data packet comprises a header, and wherein the header comprises the information indicative of an upstream volume of video traffic.

24. The multiplexer of claim 23, wherein the logic is adapted to obtain from the header the information indicative of an upstream volume of video traffic; and regulate, in accordance with the upstream volume of traffic, an amount of traffic buffered in the buffer.

25. The multiplexer of claim 23, wherein the logic is adapted to receive the information indicative of an upstream volume of video traffic in a real-time-protocol packet, wherein the real-time-protocol packet comprises at least one contributing-source-identifier field, and wherein the at least one contributing-source-identifier field comprises the information indicative of an upstream volume of video traffic.
